(19) United States
(12) Patent Application Publication
(10) Pub. No.: US 2025/0238722 A1
(43) Pub. Date: Jul. 24, 2025

(54) PER-CORE GRADIENT CLIPPING IN MULTI-CORE TRAINING OF MACHINE LEARNING (ML) MODEL(S)

(71) Applicant: GOOGLE LLC, Mountain View, CA (US)

(72) Inventors: Lun Wang, Fremont, CA (US); Om Thakkar, Sunnyvale, CA (US); Arun Narayanan, Milpitas, CA (US); Abhradeep Guha Thakurta, Santa Clara, CA (US); Rajiv Mathews, Sunnyvale, CA (US)

(21) Appl. No.: 18/924,568

(22) Filed: Oct. 23, 2024

Related U.S. Application Data
(60) Provisional application No. 63/624,134, filed on Jan. 23, 2024.

(51) Int. Cl. G06N 20/00; G06F 40/40; G06V 10/774; G10L 13/04; G10L 15/06

(52) U.S. Cl. CPC G06N 20/00; G06F 40/40; G06V 10/774; G10L 15/063; G10L 13/04

(57) ABSTRACT

Implementations described herein are directed to techniques for eliminating and/or mitigating memorization by machine learning (ML) model(s). Processor(s) can obtain a plurality of training instances to be utilized in training a ML model, identify a plurality of compute cores (e.g., TPUs, GPUs, CPUs, FPGAs, ASICs, etc.), and generate a corresponding per-core gradient at each of the plurality of compute cores. Further, the processor(s) can update the ML model based on the corresponding per-core gradients. In generating the corresponding per-core gradient at a given compute core, the processor(s) can generate corresponding gradients based on a subset of the training instances, determine, based on the corresponding gradients, a corresponding mean gradient, and clip, based on a clipping bound, the corresponding mean gradient for the given compute core to generate the corresponding per-core gradient.

### BACKGROUND

Machine learning (ML) model(s) are typically trained based on a plurality of training instances. In some instances, one or more of the plurality of training instances are generated based on data that is publicly available (e.g., from a public data repository that is accessible to central server(s) via centralized learning). In other instances, one or more of the plurality of training instances are generated based on data that is personal to a given user (e.g., from a given client device data repository that is accessible to the central server(s) via decentralized learning). For example, in training an automatic speech recognition (ASR) model, audio data can be obtained from a public audio or audio-visual data repository. Further, the audio data can be processed, using the ASR model, to generate ASR output that corresponds to, for instance, predicted text that is predicted to correspond to speech captured in the audio data. Moreover, the predicted text that is predicted to correspond to the speech captured in the audio data can be compared to ground truth text that actually corresponds to the speech captured in the audio data. Accordingly, and based on comparing the predicted text to the ground truth text, a gradient can be generated and utilized to update the ASR model.

However, these ML model(s) can unintentionally memorize one or more of the plurality of training instances. As a result, and during inference, these ML model(s) can disclose potentially sensitive information via leakage, thereby causing privacy and data security concerns. Further, this unintentional memorization makes it difficult to determine at inference time whether these ML model(s) are generalizing well by virtue of being trained based on the plurality of training instances or whether these ML model(s) have unintentionally memorized one or more of the plurality of training instances. Continuing with the above example where the ML model being trained is an ASR model, assume that, subsequent to the ASR model being trained and during benchmark testing of the ASR model, the ASR model processes given audio data corresponding to a given training instance, from among the plurality of training instances, that was utilized in training the ASR model. Further assume that the given audio data is sped up (e.g., as compared to the speed of the given audio data during training). In this example, predicted text that is predicted to correspond to speech captured in the given audio data accurately reflecting ground truth text (or portion(s) thereof) for the speech captured in the given audio data can be utilized as a signal that the ASR model unintentionally memorized the given training instance.

Various techniques have been proposed to address unintentional memorization by ML model(s). One technique that has been proposed is applying per-example gradient clipping during training of these ML model(s). In applying per-example gradient clipping during training, a corresponding gradient that is generated for each training instance is fixed to an L2 norm bound if it is larger than a fixed bound. As a result, how much the corresponding gradient (and the training instance based on which the corresponding gradient is generated) can influence these ML model(s) is also bounded, thereby mitigating instances of unintentional memorization by these ML model(s). However, in applying per-example gradient clipping during training, both the duration of time spent training these ML model(s) and computational resources consumed in training these ML model(s) is increased since it requires materializing per-example gradients during training. Accordingly, there is a need in the art for techniques to mitigate and/or eliminate unintended memorization by these ML model(s), without negatively impacting the duration of time spent training these ML model(s) and/or negatively impacting computational resources consumed in training these ML model(s), and while maintaining accuracy of state-of-the-art ML model(s).

### Summary

Implementations described herein are directed to techniques for eliminating and/or mitigating memorization by machine learning (ML) model(s) through utilization of per-core gradient clipping during training of the ML model(s). Remote processor(s) of a remote system (e.g., a high-performance server or cluster of high-performance servers) can obtain a plurality of training instances to be utilized in training a ML model, identify a plurality of compute cores of the remote system (e.g., tensor processing units (TPUs), graphics processing units (GPUs), central processing units (CPUs), field programmable gate arrays (FPGAs), or application-specific integrated circuits (ASICs), etc.), and generate a corresponding per-core gradient at each of the plurality of compute cores of the remote system based on one or more of the plurality of training instances. Further, the remote processor(s) can update the ML model based on the corresponding per-core gradients generated for each of the plurality of compute cores.

Notably, and in generating the corresponding per-core gradient at a given compute core, of the plurality of compute cores, the remote processor(s) can process, using the ML model, a corresponding subset of the plurality of training instances to generate corresponding gradients, determine, based on the corresponding gradients for each training instance included in the corresponding subset of the plurality of training instances, a corresponding mean gradient, and clip, based on a clipping bound, the corresponding mean gradient for the given compute core to generate the corresponding per-core gradient. This process can be repeated at each of the plurality of compute cores to generate the corresponding per-core gradients, hence the phrase “per-core gradient clipping”. As a result, the remote processor(s) effectively shard the corresponding gradients into micro-batches (e.g., via each of the compute cores of the remote system), average the corresponding gradients, and then apply clipping in generating the corresponding per-core gradient. By utilizing this per-core gradient clipping technique, any negative impact to the duration of time spent training the ML model and/or negative impact to the computational resources consumed in training the ML model is mitigated and/or eliminated.

In some implementations, the clipping bound can define a maximum size of the corresponding per-core gradient. In some versions of those implementations, the clipping bound can be a fixed clipping bound that is determined (e.g., defined by a developer) prior to generating the corresponding per-core gradients at each of the plurality of compute cores of the remote system. In other versions of those implementations, the clipping bound can be a dynamic clipping bound that is determined based on a smallest corresponding per-core gradient generated across the plurality of compute cores of the remote system. By defining the maximum size of the corresponding per-core gradient via the clipping bound, none of the corresponding gradients generated based on processing the subset of the plurality of training instances can unboundedly impact the ML model, thereby eliminating and/or mitigating memorization by the ML model during training. Put another way, the corresponding gradients generated based on processing the subset of plurality of training instances can only impact the ML model in a bounded capacity.

In some implementations, and in generating the corresponding per-core gradient at the given compute core, the remote processor(s) can initialize a corresponding instance of the corresponding instance of the ML model. Accordingly, and in generating the corresponding per-core gradient at each of the plurality of compute cores, a corresponding instance of the ML model is effectively initialized at each of the plurality of compute cores. In some versions of those implementations, the remote processor(s) can select the corresponding subset of the plurality of training instances to be processed at each of the plurality of compute cores. Notably, a quantity of training instances that are selected for inclusion in the corresponding subset of the plurality of training instances can be based on one or more criteria. The one or more criteria can include, for example, a model size of the instance of the ML model, a training instance size of the plurality of training instances, and/or other criteria. Put another way, the remote processor(s) balance at least a size of the corresponding instance of the ML model and a training instance size of each of the plurality of training instances in causing different training instances to be selected for inclusion in different corresponding subsets of the plurality of training instances. For example, and assuming that the ML model being trained is an audio-based ML model, the corresponding instances of the ML model executed at each of the plurality of compute cores should be the same size. However, some of the training instances may include audio data that is longer and, as a result, is effectively a larger size than other training instances.

In some implementations, the ML model that is being trained can be an audio-based ML model. The audio-based ML model can be, for example, an automatic speech recognition (ASR) model, a hotword model, a continued conversation model, and/or other audio-based ML models. In some versions of these implementations, the remote processor(s) can obtain a plurality of audio data instances (e.g., from an audio or audio-visual data repository) and obtain a corresponding training signal for each of the plurality of audio data instances. For example, in implementations where the ML model is an ASR model, the plurality of audio data instances can include speech and the corresponding training signal for each of the plurality of audio data instances can include a ground truth transcription for the speech captured in the plurality of audio data instances. As another example, in implementations where the ML model is a hotword model, the plurality of audio data instances can include speech and the corresponding training signal for each of the plurality of audio data instances can include a ground truth indication of whether the speech captured in the plurality of audio data instances captures a particular word or phrase that, when detected, invoked an automated assistant. As yet another example, in implementations where the ML model is a continued conversation model, the plurality of audio data instances can include speech and the corresponding training signal for each of the plurality of audio data instances can include a ground truth indication of whether component(s) of the automated assistant should remain active in anticipation of receiving further audio data. In additional or alternative versions of these implementations, the remote processor(s) can obtain a plurality of textual data instances (e.g., from textual data repository), process the plurality of textual data instances to generate the plurality of audio data instances (e.g., using a text-to-speech (TTS) model) and a corresponding training signal for each of the plurality of textual data instances. Accordingly, and in generating the corresponding gradients using an audio-based ML model, the remote processor(s) can cause the audio-based ML model to process a given audio data instance for a given training instance to generate given predicted audio-based output, compare the given predicted audio-based output to the corresponding training signal, and generate a given corresponding gradient based on comparing the given predicted audio-based output and the corresponding training signal.

In additional or alternative implementations, the ML model that is being trained can be a vision-based ML model. The vision-based ML model can be, for example, a visual language model (VLM), an object analysis model (e.g., an object detection model, an object classification model, etc.), a hotword free invocation model, and/or other vision-based ML models. In some versions of these implementations, the remote processor(s) can obtain a plurality of vision data instances (e.g., images or a sequence of images (e.g., video frames) from a vision data repository) and obtain a corresponding training signal for each of the plurality of vision data instances. For example, in implementations where the ML model is a VLM, the plurality of vision data instances can include an image (and optionally a prompt asking a question or the like about the image) and the corresponding training signal for each of the plurality of vision data instances can include ground truth information about objects, entities, or the like captured in the plurality of vision data instances. As another example, in implementations where the ML model is an object analysis model, the plurality of vision data instances can include an image and the corresponding training signal for each of the plurality of vision data instances can include a ground truth signal with respect to objects that are captured in the image, bounding boxes for objects captured in the image, etc. As yet another example, in implementations where the ML model is a hotword free invocation model, the plurality of vision data instances can include an image of a person making a gesture and the corresponding training signal for each of the plurality of audio data instances can include a ground truth indication of whether the person making the gesture should invoke or otherwise control an automated assistant. Accordingly, and in generating the corresponding gradients using an vision-based ML model, the remote processor(s) can cause the vision-based ML model to process a given vision data instance for a given training instance to generate given predicted vision-based output, compare the given predicted vision-based output to the corresponding training signal, and generate a given corresponding gradient based on comparing the given predicted vision-based output and the corresponding training signal.

In additional or alternative implementations, the ML model that is being trained can be a text-based ML model. The text-based ML model can be, for example, a language model (LM), a large language model (LLM), a natural language understanding (NLU) model, and/or other text-based ML models. In some versions of these implementations, the remote processor(s) can obtain a plurality of textual data instances (e.g., text from a textual data repository) and obtain a corresponding training signal for each of the plurality of textual data instances. For example, in implementations where the ML model is a LM or an LLM, the plurality of textual data instances can include text (and optionally a prompt asking a question or the like about the text or a task to be performed with respect to the text (e.g., a summarization task or the like)) and the corresponding training signal for each of the plurality of vision data instances can include ground truth information about the text, a ground truth token or ground truth sequence of tokens for text that is predicted to follow, etc. As another example, in implementations where the ML model is a NLU model, the plurality of textual data instances can include a text and the corresponding training signal for each of the plurality of textual data instances can include intent(s), slot value(s) for parameter(s) associated with the intent(s), and/or other information related to the text. Accordingly, and in generating the corresponding gradients using an text-based ML model, the remote processor(s) can cause the text-based ML model to process a given textual data instance for a given training instance to generate given predicted text-based output, compare the given predicted text-based output to the corresponding training signal, and generate a given corresponding gradient based on comparing the given predicted text-based output and the corresponding training signal.

Although certain types of ML models and certain ML models of each type are described above, it should be understood that those certain types of those certain ML models of each type are provided for the sake of example and are not meant to be limiting. Rather, it should be understood that the techniques described herein can be utilized to reduce memorization in training any ML model that is capable of being executed by a given compute core (or a subset of compute cores) of the remote system. Further, although generating the gradients is described above as using supervised learning techniques, it should be understood that is also for the sake of example and is not meant to be limiting. Rather, it should be understood that unsupervised learning (or semi-supervised learning) (e.g., masking, student-teacher, and/or other techniques) can additionally, or alternatively, be utilized in implementations when a supervision signal is not available.

Implementations described herein are additionally, or alternatively, directed to techniques for determining an extent of memorization by ASR models that were previously trained. The remote processor(s) can obtain an ASR model that was previously trained and obtain a plurality of testing instances for benchmark testing of the ASR model. Notably, the plurality of testing instances can include at least a holdout set of testing instances (e.g., that are unseen by the ASR model during the previous training) and a canary set of testing instances (e.g., that were seen by the ASR model during the previous training). Further, the remote processor(s) can process a corresponding audio data for each of the plurality of testing instances to generate a corresponding predicted ASR output for each of the plurality of testing instances, determine, based on comparing the corresponding predicted ASR output for each of the plurality of testing instances to a corresponding ground truth ASR output for each of the plurality of testing instances, a corresponding error rate for each of the plurality of testing instances, and determine, based on comparing the corresponding error rate for the holdout set of testing instances to the corresponding error rate for the canary set of testing instances, an extent of memorization by the ASR model from the previous training. Moreover, and based on the extent of memorization by the ASR model from the previous training, the remote processor(s) can determine a suggested action with respect to the ASR model.

In some implementations, the corresponding error rate for each of the plurality of testing instances is a corresponding character error rate (CER) that indicates a character-by-character error for the corresponding predicted ASR output as compared to the corresponding ground truth ASR output. Accordingly, in these implementations, performance of the ASR model can be evaluated on a character-by-character basis. In additional or alternative implementations, the corresponding error rate for each of the plurality of testing instances is a corresponding word error rate (WER) that indicates a word-by-word error for the corresponding predicted ASR output as compared to the corresponding ground truth ASR output. Accordingly, in these implementations, performance of the ASR model can be evaluated on a word-by-word basis.

In some implementations, the corresponding audio data for each testing instance, included in the canary set of testing instances, is sped up as compared to corresponding training audio data that was processed by the ASR model during the previous training. Accordingly, in these implementations, a relatively low CER and/or WER for the canary testing instances can be indicative of the ASR model having memorized some of the training instances that are included as testing instances in the canary set of testing instances. Put another way, the speed at which the audio data is rendered for canary testing instances can be increased (e.g., 1.5×, 2×, etc. as specified during TTS of the canary testing instances), and strong performance on these canary testing instances, relative to poor performance of on the holdout testing instances, can be utilized as a proxy signal to indicate that the ASR model memorized some of the training instances during training.

In some implementations, the ASR model can be a first-party ASR model that was previously trained by a first-party entity. In other implementations, the ASR model can be a third-party ASR model that was previously trained by a third-party entity. As used herein, the term “first-party” or “first-party entity” refers to an entity that develops and/or maintains the remote system, whereas the term “third-party” or “third-party entity” refers to an entity that is distinct from the entity that develops and/or maintains the remote system. Accordingly, any ASR models that are developed and/or maintained by the entity that develops and/or maintains the remote system may be referred to as “first-party ASR models”. Similarly, any ASR models that are developed and/or maintained by any entity other than the entity that develops and/or maintains the remote system may be referred to as “third-party ASR models”.

In some implementations, and in determining a suggested action with respect to the ASR model based on the extent of memorization by the ASR model from the previous training, the remote processor(s) can determine whether the extent of memorization by the ASR model from the previous training satisfies a memorization threshold. In these implementations, and in response to determining that the extent of memorization by the ASR model from the previous training satisfies the memorization threshold, the remote processor(s) can determine that the ASR model needs to be re-trained or needs further training, and generate the suggested action that indicates that the ASR model needs to be re-trained or needs further training. The suggested action can be provided for presentation to a first-party and/or third-party developer (e.g., depending on whether the ASR model is a first-party ASR model or a third-party ASR model). Further, and in response to determining that the extent of memorization by the ASR model from the previous training fails to satisfy the memorization threshold, the remote processor(s) can determine that the ASR model should be deployed, and generate the suggested action that indicates that the ASR model should be deployed. Similarly, the suggested action can be provided for presentation to a first-party and/or third-party developer (e.g., depending on whether the ASR model is a first-party ASR model or a third-party ASR model).

The above description is provided as an overview of only some implementations disclosed herein. Those implementations, and other implementations, are described in additional detail herein.

### BRIEF DESCRIPTION OF THE DRAWINGS

FIG. 1 depicts a block diagram of an example environment that demonstrates various aspects of the present disclosure, in accordance with various implementations.

FIG. 2 depicts another block diagram of an example environment that demonstrates various aspects of the present disclosure, in accordance with various implementations.

FIG. 3 depicts yet another block diagram of an example environment that demonstrates various aspects of the present disclosure, in accordance with various implementations.

FIG. 4 depicts a flowchart illustrating a method of training a machine learning (ML) model using a per-core gradient clipping technique, in accordance with various implementations.

FIG. 5 depicts a flowchart illustrating a method of benchmark testing of an automatic speech recognition (ASR) model, in accordance with various implementations.

FIG. 6 depicts an example architecture of a computing device, in accordance with various implementations.

### DETAILED DESCRIPTION

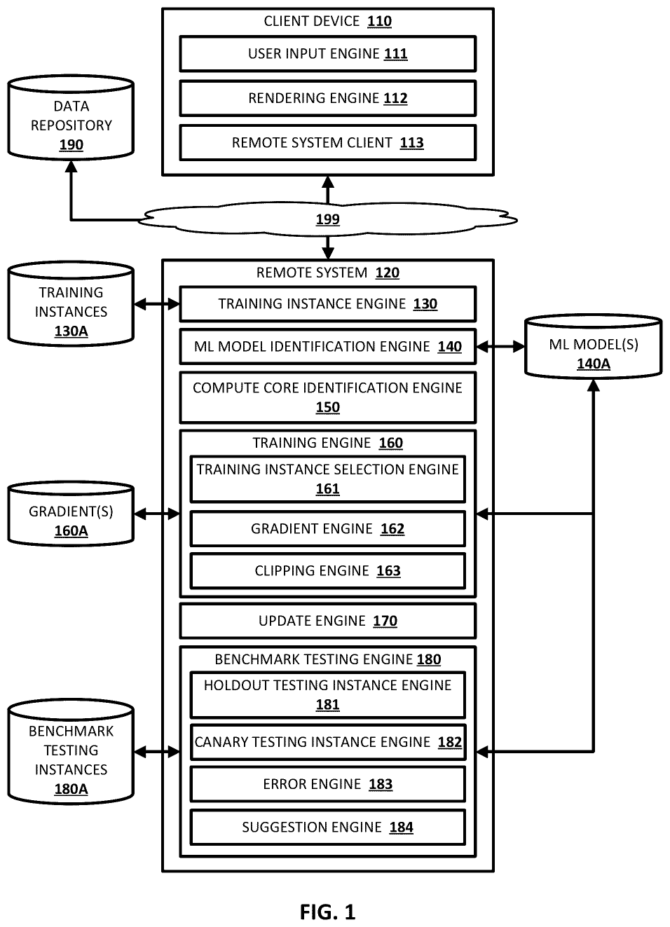

Turning now to FIG. 1, a block diagram of an example environment that demonstrates various aspects of the present disclosure is depicted. A client device 110 is illustrated in FIG. 1, and includes, in various implementations, a user input engine 111, a rendering engine 112, and a remote system client 113. The client device 110 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device, etc.). Additional and/or alternative client devices may be provided.

The user input engine 111 can detect various types of user input at the client device 110. In some examples, the user input detected at the client device 110 can include spoken utterance(s) of a human user of the client device 110 that is detected via microphone(s) of the client device 110. In these examples, the microphone(s) of the client device 110 can generate audio data that captures the spoken utterance(s). In other examples, the user input detected at the client device 110 can include touch input of a human user of the client device 110 that is detected via user interface input device(s) (e.g., touch sensitive display(s)) of the client device 110, and/or typed input detected via user interface input device(s) (e.g., touch sensitive display(s) and/or keyboard(s)) of the client device 110. In these examples, the user interface input device(s) of the client device 110 can generate textual data that captures the touch input and/or the typed input.

The rendering engine 112 can cause content and/or other output to be visually rendered for presentation to the user at the client device 110 (e.g., via a touch sensitive display or other user interface output device(s)) and/or audibly rendered for presentation to the user at the client device 110 (e.g., via speaker(s) or other user interface output device(s)). The content and/or other output can include, for example, suggested actions to be performed with respect to machine learning (ML) model(s) any other content and/or output described herein.

Further, the client device 110 is illustrated in FIG. 1 as communicatively coupled, over one or more networks 199 (e.g., any combination of Wi-Fi®, Bluetooth®, or other local area networks (LANs); ethernet, the Internet, or other wide area networks (WANs); and/or other networks), to a remote system 120. The remote system 120 can be, for example, a high-performance server, a cluster of high-performance servers, and/or any other computing device that is remote from the client device 110. The remote system 120 includes, in various implementations, a training instance engine 130, a ML model identification engine 140, a compute core identification engine 150, a training engine 160, an update engine 170, and a benchmark testing engine 180. The training engine 160 can include various sub-engines, such as a training instance selection engine 161, a gradient engine 162, and a clipping engine 163. Further, the benchmark testing engine 180 can include various sub-engines, such as a holdout testing instance engine 181, a canary testing instance engine 182, an error engine 183, and a suggestion engine 184. Although various sub-engines are depicted in FIG. 1, it should be understood that is for the sake of describing various techniques contemplated herein and is not meant to be limiting. For instance, one or more of the various sub-engines can be combined, while one or more of the other various sub-engines can be omitted.

The remote system 120 can interact with various databases. For instance, the training instance engine 130 can interact with data repository 190 to obtain data for generating training instances and storing the training instances in training instances database 130A. Further, the ML model identification engine 140 can interact with ML model(s) database 140A that stores various ML model(s) to identify a ML model to be trained and/or evaluated, the training engine 160 can interact with the ML model(s) database 140A to train the ML model that is identified, and the benchmark testing engine 180 can interact with the ML model(s) database 140A to evaluate the ML model that is identifier. Moreover, the training engine 160 can interact with gradient(s) database 160A to store gradient(s) generated during training of the ML model and for subsequent utilization of the gradient(s) during training. Furthermore, the benchmark testing engine 180 can interact with data repository 190 to obtain data for generating testing instances and storing the testing instances in benchmark testing instances database 180A. Although FIG. 1 is depicted with respect to certain engines and/or sub-engines of the remote system 120 having access to certain databases, it should be understood that is for the sake of example and is not meant to be limiting.

Moreover, the client device 110 can execute the remote system client 113. An instance of the remote system client 113 can be an application that is separate from an operating system of the client device 110 (e.g., installed “on top” of the operating system)—or can alternatively be implemented directly by the operating system of the client device 110. The remote system client 113 enables a user of the client device (e.g., a developer associated with the remote system 120) to interact with the remote system 120 during training and/or evaluation of a ML model.

Furthermore, the client device 110 and/or remote system 120 may include one or more memories for storage of data and software applications, one or more processors for accessing data and executing the software applications, and other components that facilitate communication over one or more of the networks 199. In some implementations, one or more of the software applications can be installed locally at the client device 110, whereas in other implementations one or more of the software applications can be hosted remotely from the client device 110 (e.g., by one or more servers), but accessible by the client device 110 over one or more of the networks 199.

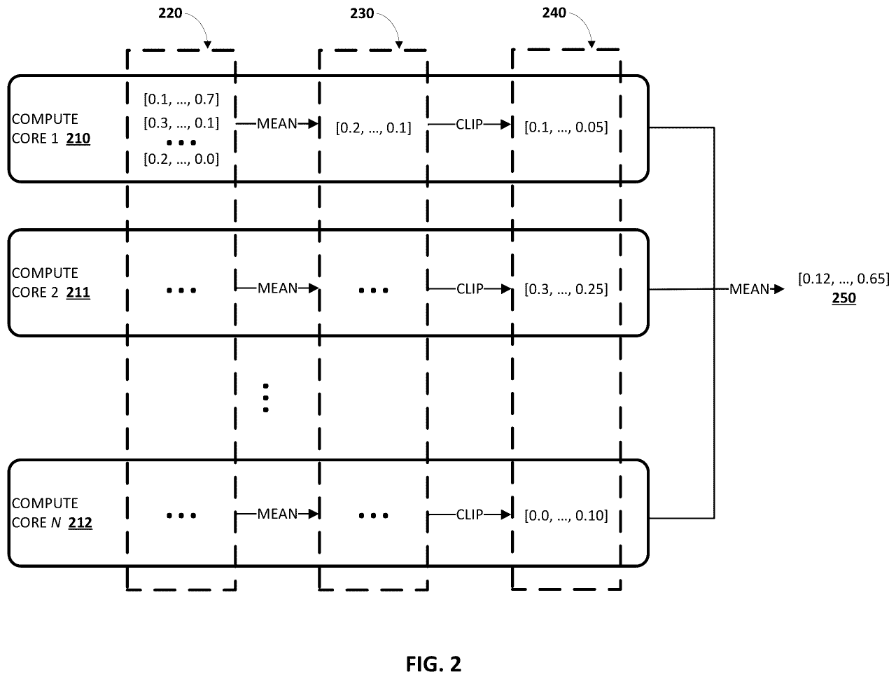

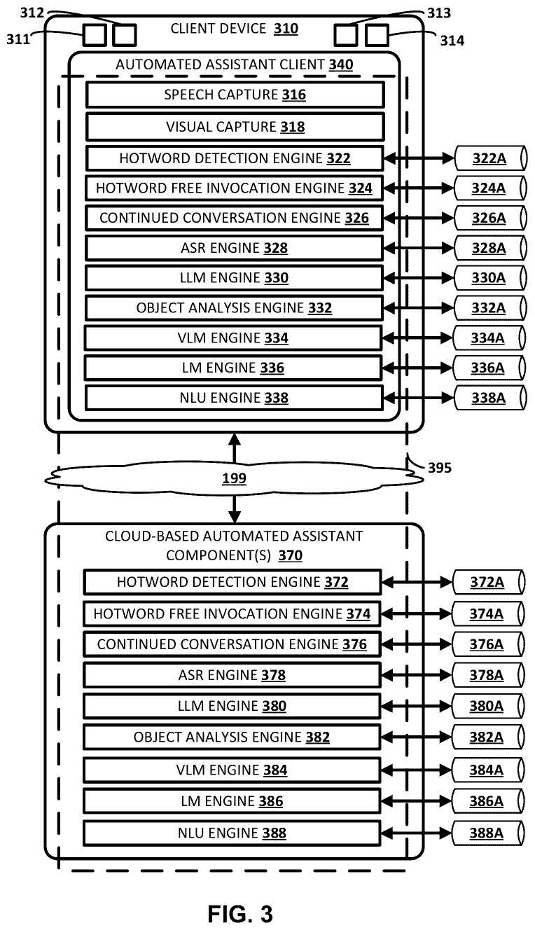

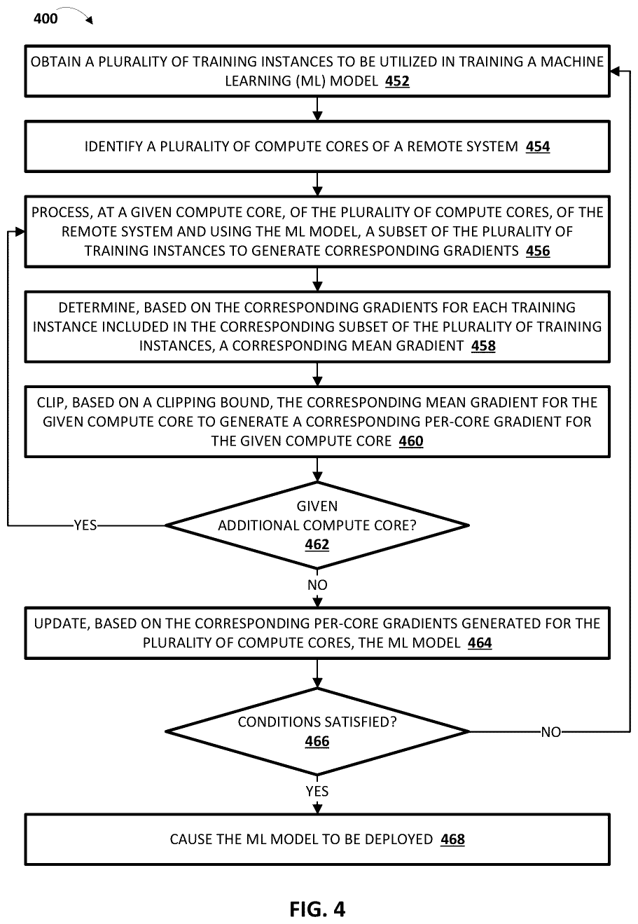

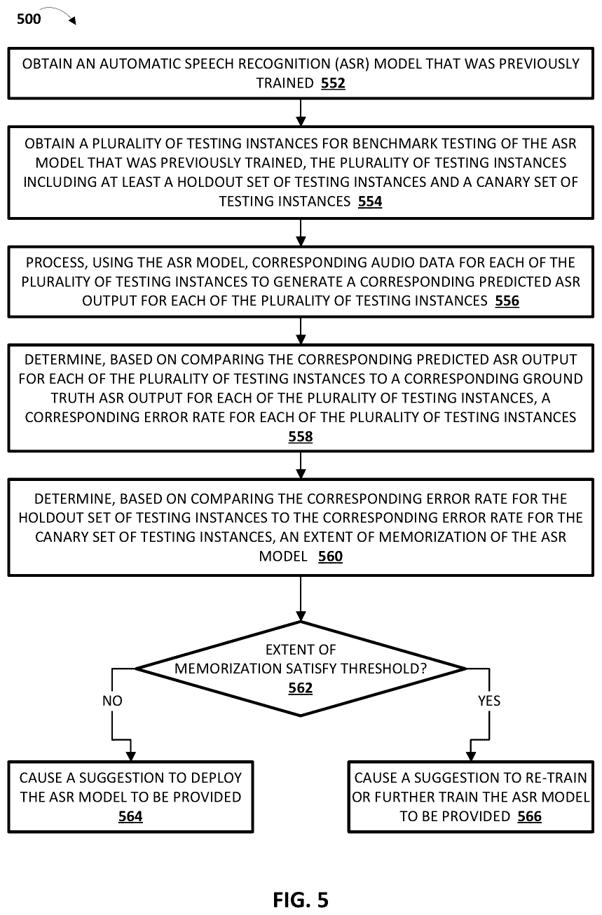

As described herein, the remote system 120 can be utilized to train various ML models (e.g., as described with respect to FIG. 3) using a per-core gradient clipping technique (e.g., as described with FIGS. 2 and 4). By using the per-core gradient clipping technique described herein, instances of the various ML models memorizing training data is mitigated and/or eliminated, thereby increasing data security and data privacy by mitigating and/or eliminating attacks on the ML model to inadvertently reveal training instances that were utilized to train the ML model. Further, by using the per-core gradient clipping technique described herein, these advantages are achieved without negatively impacting the duration of training of the ML model and/or without negatively impacting computational costs in training the ML model as compared to other techniques (e.g., as compared to per-example gradient clipping). As also described herein, the remote system 120 can be utilized to evaluate automatic speech recognition (ASR) models using a benchmark testing technique (e.g., as described with FIG. 5) to determine an extent of memorization by the ASR model during prior training. Based on an extent of memorization by the ASR model during the prior training, the remote system 120 can suggest action(s) to be performed to mitigate and/or eliminate the memorization by the ASR model.

Although FIG. 1 is described with respect to a single client device having a single user, it should be understood that is for the sake of example and is not meant to be limiting. For example, one or more additional client devices of a user can also implement the techniques described herein. For instance, the client device 110, the one or more additional client devices, and/or any other computing devices of the user can form an ecosystem of devices that can employ techniques described herein. These additional client devices and/or computing devices may be in communication with the client device 110 and/or the remote system 120 (e.g., over the one or more networks 199). As another example, a given client device can be utilized by multiple users in a shared setting (e.g., a group of users, a household, etc.). Additional description of the remote system is provided herein (e.g., with respect to FIGS. 2, 4, and 5).

Turning now to FIG. 2, another block diagram of an example environment that demonstrates various aspects of the present disclosure is depicted. A plurality of compute cores 210, 211, 212 are depicted. The plurality of compute cores 210, 211, 212 can be executed by a remote system (e.g., the remote system 120 of FIG. 1). In particular, the plurality of compute cores can be executed by a single high-performance server in a centralized manner, or can be executed by multiple high-performance servers in a distributed manner. Assuming that a plurality of training instances are available (e.g., that were previously generated and/or obtained via the training instance engine as described with respect to FIG. 3), the remote system 120 can cause the training instance engine 130 to obtain to the plurality of training instances for utilization in training a ML model and cause the ML model identification engine 140 to identify the ML model to be trained. Further, the remote system 120 can cause the compute core identification engine to identify the plurality of compute cores 210, 211, 212. The plurality of compute cores 210, 211, 212 can be, for example, tenor processing units (TPUs), central processing units (CPUs), field programmable gate arrays (FPGAs), application-specific integrated circuits (ASICs), and/or other compute cores.

Prior to training the ML model, the remote system 120 can cause the training engine 160 to initialize a corresponding instance of the ML model at each of the plurality of compute cores 210, 211, 212. For example, a first corresponding instance of the ML model can be initialized at a first compute core 210, a second corresponding instance of the ML model can be initialized at a second compute core 211, an Nth corresponding instance of the ML model can be initialized at compute core N (e.g., where N is a positive integer), and so on for each of the plurality of compute cores 210, 211, 212, and any other compute cores. Further, and prior to training the ML model, the remote system can cause the training instance selection engine 161 to select, for each of the plurality of compute cores 210, 211, 212, a corresponding subset of the plurality of training instances that were obtained by the training instance engine 130 for utilization in training the ML model. Notably, a quantity of training instances that are selected by the training instance selection engine 161 for inclusion in each of the corresponding subsets of the plurality of training instances can be based on one or more criteria. The one or more criteria can include, for example, a model size of the corresponding instance of the ML model, a training instance size of the plurality of training instances, and/or other criteria.

For example, if the model size of the corresponding instance of the ML model is relatively large, then a lesser quantity of the plurality of training instances may be selected for inclusion in each of the corresponding subsets of training instances. However, if the model size of the corresponding instance of the ML model is relatively small, then a greater quantity of the plurality of training instances may be selected for inclusion in each of the corresponding subsets of training instances. Notably, the model size of the corresponding instance of the ML model may vary based on a type of the ML model (e.g., an audio-based ML model, a vision-based ML model, a text-based ML model, a multi-modal ML model, etc.), a number of parameters of the ML model, a number of layers of the ML model, and/or based on other factors related to an architecture of the ML model. As another example, if the training instance size of the plurality of training instances is relatively large, then a lesser quantity of the plurality of training instances may be selected for inclusion in each of the corresponding subsets of training instances. However, if the training instance size of the plurality of training instances is relatively small, then a greater quantity of the plurality of training instances may be selected for inclusion in each of the corresponding subsets of training instances. Notably, the training instance size of the plurality of training instances may vary based on a type of the training instances (e.g., audio-based training instances utilized to train an audio-based ML model, vision-based training instances utilized to train a vision-based ML model, text-based training instances utilized to train a text-based ML model, multi-modal training instances utilized to train a multi-modal ML model) and/or based on other factors related to information embodied by one or more of the plurality of training instances.

In some implementations, a quantity of training instances that are selected by the training instance selection engine 161 for inclusion in each of the corresponding subsets may be the same for each of the plurality of compute cores. For example, each of the plurality of compute cores may process the same quantity of training instances to generate the same quantity of corresponding gradients at each of the plurality of compute cores 210, 211, 212. In other implementations, a quantity of training instances that are selected by the training instance selection engine 161 for inclusion in each of the corresponding subsets may differ across the plurality of compute cores. For example, each of the plurality of compute cores may process different quantities of training instances to generate different quantities of corresponding gradients at each of the plurality of compute cores 210, 211, 212.

In some implementations, each of the corresponding subsets of training instances that are selected by the training instance selection engine 161 may be mutually exclusive in that each of the corresponding subsets of training instances include training instances that are unique to a given corresponding subset of the plurality of training instances. In additional or alternative implementations, one or more of the corresponding subsets of training instances that are selected by the training instance selection engine 161 may not be mutually exclusive in that one or more of the corresponding subsets of training instances may include the same training instance.

Further assume that a corresponding instance of the ML model is initialized at each of the compute cores 210, 211, 212, and assume that and a corresponding subset of the plurality of training instances are selected for each of the plurality of compute cores 210, 211, 212. The remote system 120 can cause the gradient engine 162 to generate a corresponding gradient for each training instance included in the corresponding subsets of the plurality of training instances. For example, the gradient engine 162 can process, using the first corresponding instance of the ML model that initialized at the first compute core 210, to process each training instance, included in a first subset of the corresponding training instances selected by the training instance selection engine 161 for the first compute core 210 to generate first corresponding gradients for the first compute core 210. Further, the gradient engine 162 can process, using the second corresponding instance of the ML model that initialized at the second compute core 211, to process each training instance, included in a second subset of the corresponding training instances selected by the training instance selection engine 161 for the second compute core 211 to generate second corresponding gradients for the second compute core 211. This process can be repeated for each of the plurality of compute cores 210, 211, 212 up until the Nth compute core 212.

The corresponding gradients that are generated at each of the plurality of compute cores 210, 211, 212 are indicated generally by the box 220 that encompasses multiple gradients that are generated at each of the plurality of compute cores 210, 211, 212. In various implementations, as the corresponding gradients are generated, they can be stored in a transitory or non-transitory database (e.g., the gradient(s) database 160A). This enables the gradient engine 162 to determine a corresponding mean gradient for each of the plurality of compute cores 210, 211, 212 are indicated generally by the box 230 that encompasses a single corresponding mean gradient at each of the plurality of compute cores 210, 211, 212.

Further, the corresponding mean gradient that is generated at each of the plurality of compute cores 210, 211, 212 can be clipped, via the clipping engine 163 and based on a clipping bound, to generate a corresponding per-core gradient at each of the plurality of compute 210, 211, 212. The corresponding per-core gradients are indicated generally by the box 240 that encompasses a single corresponding per-core gradient at each of the plurality of compute cores 210, 211, 212. Notably, the clipping bound can define a maximum size of the corresponding per-core gradients. In some implementations, the clipping bound can be a fixed clipping bound that is determined (e.g., defined by a developer) prior to generating the corresponding per-core gradients at each of the plurality of compute cores 210, 211, 212. In other implementations, the clipping bound can be a dynamic clipping bound that is determined based on a smallest corresponding per-core gradient generated across the plurality of compute cores 210, 211, 212. By defining the maximum size of the corresponding per-core gradient via the clipping bound, none of the corresponding gradients generated based on processing the subset of the plurality of training instances can impact the ML model, thereby eliminating and/or mitigating memorization by the ML model during training.

In some implementations, the ML model can then be updated based on each of the corresponding per-core gradients that are indicated by the box 240 that encompasses a single corresponding per-core gradient at each of the plurality of compute cores 210, 211, 212. For example, the corresponding per-core gradients that are indicated by the box 240 can be backpropagated across the ML model to update the ML model. In additional or alternative implementations, the ML model can then be updated based on a mean of each of the corresponding per-core gradients that are indicated by 250. For example, the mean of the corresponding per-core gradients that are indicated by 250 can be backpropagated across the ML model to update the ML model.

Although the block diagram of FIG. 2 is described without describing any particular ML model or particular technique for generating the corresponding gradients generally indicated by box 220, it should be understood that is for the sake of brevity and is not meant to be limiting. For example, it should be understood that the per-core gradient clipping technique described herein can be utilized to train various audio-based ML models, vision-based ML models, text-based ML models, multi-modal ML models, etc. (e.g., as described with respect to FIG. 3). As a result, it should be understood that content of the training instances utilized in generating the corresponding gradients to train these various different types of ML models, and even different ML models of the same type, will vary. Nonetheless, and despite the variations of these different types of ML models and variations of the different ML models of the same types, the per-core gradient clipping technique described herein can still be utilized to train these various ML models. As another example, it should be understood that various different learning techniques for generating the corresponding gradients are contemplated herein.

Turning now to FIG. 3, a client device 210 is illustrated in an implementation where various on-device ML engines are included as part of (or in communication with) an automated assistant client 340 is depicted. The respective on-device ML models are also illustrated interfacing with the various on-device ML engines. Other components of the client device 310 are not illustrated in FIG. 3 for simplicity. FIG. 3 illustrates one example of how the various on-device ML engines of and their respective ML models can be utilized by the automated assistant client 340 in performing various actions.

The client device 310 in FIG. 3 is illustrated with one or more microphones 311, one or more speakers 312, one or more vision components 313, and display(s) 314 (e.g., a touch-sensitive display). The client device 310 may further include pressure sensor(s), proximity sensor(s), accelerometer(s), magnetometer(s), and/or other sensor(s) that are used to generate other sensor data that is in addition to audio data captured by the one or more microphones 311. The client device 310 at least selectively executes the automated assistant client 340. The automated assistant client 340 includes, in the example of FIG. 3, hotword detection engine 322, hotword free invocation engine 324, continued conversation engine 326, ASR engine 328, large language model (LLM) engine 330, object analysis engine 332, visual language model (VLM) engine 334, and language model (LM) engine 336. The automated assistant client 340 further includes speech capture engine 316, and visual capture engine 318. It should be understood that the on-device ML engines and on-device ML models depicted in FIG. 3 are provided for the sake of example, and are not meant to be limiting. For example, the automated assistant client 340 can further include additional and/or alternative on-device ML engines, such as a text-to-speech (TTS) engine and a respective on-device TTS model, a voice activity detection (VAD) engine and a respective on-device VAD model, an endpoint detector engine and a respective on-device endpoint detector model, a lip movement engine and a respective on-device lip movement model, and/or other on-device engine(s) along with associated on-device ML model(s). Moreover, it should be understood that one or more of the on-device ML engines and/or on-device ML models described herein can be combined, such that a single on-device ML engine and/or on-device ML model can perform the functions of multiple on-device ML engines and/or on-device ML models described herein.

One or more cloud-based automated assistant components 370 can optionally be implemented on one or more computing systems (collectively referred to as a “cloud” computing system) that are communicatively coupled to client device 310 via one or more of the networks described with respect to FIG. 1 as indicated generally by 399. The cloud-based automated assistant components 370 can be implemented, for example, via a cluster of high-performance servers. In various implementations, an instance of an automated assistant client 340, by way of its interactions with one or more cloud-based automated assistant components 370, may form what appears to be, from a user's perspective, a logical instance of an automated assistant as indicated generally by 395 with which the user may engage in a human-to-computer interactions (e.g., spoken interactions, gesture-based interactions, and/or touch-based interactions).

The client device 310 can be, for example: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a smart appliance such as a smart television (or a standard television equipped with a networked dongle with automated assistant capabilities), and/or a wearable apparatus of the user that includes a computing device (e.g., a watch of the user having a computing device, glasses of the user having a computing device, a virtual or augmented reality computing device). Additional and/or alternative client devices may be provided.

The one or more vision components 313 can take various forms, such as monographic cameras, stereographic cameras, a LIDAR component (or other laser-based component(s)), a radar component, etc. The one or more vision components 313 may be used, e.g., by the visual capture engine 318, to capture image data corresponding to vision frames (e.g., image frames, laser-based vision frames) of an environment in which the client device 310 is deployed. In some implementations, such vision frame(s) can be utilized to determine whether a user is present near the client device 310 and/or a distance of the user (e.g., the user's face) relative to the client device 310. Such determination(s) can be utilized, for example, in determining whether to activate the various on-device ML engines depicted in FIG. 3, and/or other on-device ML engine(s). Further, the speech capture engine 318 can be configured to capture a user's spoken utterance(s) and/or other audio data captured via the one or more of the microphones 311.

As described herein, such audio data, vision data, and textual data can be processed by the various on-device ML engines depicted in FIG. 3 to make predictions at the client device 310 using deployed on-device ML models. As some non-limiting example, the hotword detection engine 322 can utilize a hotword detection model 322A to predict whether audio data includes one or more particular words or phrases to invoke the automated assistant 395 (e.g., “Ok Google”, “Hey Google”, “What is the weather Google?”, etc.) or certain functions of the automated assistant 395; the hotword free invocation engine 324 can utilize a hotword free invocation model 324A to predict whether vision data includes a gesture or signal to invoke the automated assistant 395 (e.g., based on a gaze of the user and optionally further based on mouth movement of the user); the continued conversation engine 326 can utilize a continued conversation model 326A to predict whether further audio data is directed to the automated assistant 395 (e.g., or directed to an additional user in the environment of the client device 310); the ASR engine 328 can utilize an ASR model 328A to generate recognized text, or predict phoneme(s) and/or token(s) that correspond to audio data detected at the client device 310 and generate the recognized text based on the phoneme(s) and/or token(s); the LLM engine 330 can utilize a LLM 330A to generate an LLM response, that includes textual content, multimedia content, and/or other content that is responsive to natural language based input received at the client device and generate the LLM response based on a probability distribution over a sequence of token(s), such as word token(s), multimedia content token(s), and/or other token(s); the object analysis engine 332 can utilize an object analysis model 332A (e.g., an object detection model, an object classification model, and/or other object analysis model(s)) to predict object location(s) included in vision data of an image or video captured at the client device 310, object classification(s) of object(s) included in vision data of an image or video captured at the client device 310, and/or other information with respect to object(s) captured in vision data of an image or video; the visual language model (VLM) engine 334 can utilize a VLM 334A to process vision data (and optionally a prompt asking a question or the like about the vision data) to provide information about the vision data, such as objects included in the vision data, entities included in the vision data, information about objects and/or entities included in the vision data, and/or other information; and the LM engine 336 can utilize a LM 330A to generate an LM response, that includes textual content, multimedia content, and/or other content that is responsive to natural language based input received at the client device and generate the LM response based on a probability distribution over a sequence of token(s), such as word token(s), multimedia content token(s), and/or other token(s).

In some implementations, the client device 310 may further include natural language understanding (NLU) engine 338. The NLU engine 338 may perform on-device natural language understanding, utilizing NLU model 338A, on recognized text, predicted phoneme(s), and/or predicted token(s) generated by the ASR engine 328 to generate NLU data. The NLU data can include, for example, intent(s) that correspond to the spoken utterance and optionally slot value(s) for parameter(s) for the intent(s). In other implementations, the NLU engine 334 may be omitted, and the ASR engine 328 can generate fulfillment data directly based on the audio data and/or the LLM engine 330 (or the LM engine 336) can generate the fulfillment data directly based on the audio data and/or the ASR output. For example, assume the ASR engine 328 processes, using the ASR model 328A, a spoken utterance of “turn on the lights.” In this example, the ASR engine 328 can generate a semantic output that is then transmitted to a software application associated with the lights and/or directly to the lights that indicates that they should be turned on.

Notably, the cloud-based automated assistant component(s) 370 include cloud-based counterparts to the on-device engines and on-device models described herein with respect to FIG. 3. As some non-limiting example, the hotword detection engine 372 can utilize a hotword detection model 372A that is a cloud-based counterpart of the hotword detection engine 322 and the hotword detection model 322A; the hotword free invocation engine 374 can utilize a hotword free invocation model 374A that is a cloud-based counterpart of the hotword free invocation engine 324 and the hotword free invocation model 324A; the continued conversation engine 376 can utilize a continued conversation model 376A that is a cloud-based counterpart of the continued conversation engine 326 and the continued conversation model 326A; the ASR engine 378 can utilize an ASR model 378A that is a cloud-based counterpart of the ASR engine 328 and the ASR model 328A; the LLM engine 380 can utilize a LLM 380A that is a cloud-based counterpart of the LLM engine 330 and the LLM 330A; the object analysis engine 382 can utilize an object analysis model 382A that is a cloud-based counterpart of the object analysis engine 332 and the object analysis model 332A; the VLM engine 384 can utilize a VLM 384A that is a cloud-based counterpart of the VLM engine 334 and the VLM 334A; the LM engine 386 can utilize a LM 386A that is a cloud-based counterpart of the LM engine 336 and the LM 336A; and the NLU engine 388 can utilize a NLU model 388A that is a cloud-based counterpart of the NLU engine 338 and the NLU model 338A.

However, in various implementations, these engines and models may not be invoked since the engines and models may be transmitted directly to the client device 310 and executed locally at the client device 310 as described above with respect to FIG. 1. Nonetheless, a remote execution module can also optionally be included that performs remote execution based on local or remotely generated NLU data and/or fulfillment data. Additional and/or alternative remote engines can be included. As described herein, in various implementations on-device speech processing, on-device image processing, on-device NLU, on-device fulfillment, and/or on-device execution can be prioritized at least due to the latency and/or network usage reductions they provide when resolving a spoken utterance (due to no client-server roundtrip(s) being needed to resolve the spoken utterance). However, one or more cloud-based automated assistant component(s) 370 can be utilized at least selectively. For example, such component(s) can be utilized in parallel with on-device component(s) and output from such component(s) utilized when local component(s) fail. For example, if any of the on-device engines and/or models fail (e.g., due to relatively limited resources of the client device 310), then the more robust resources of the cloud may be utilized.

Although certain audio-based, vision-based, text-based engines, and multi-modal ML models, are described with respect to FIG. 3, it should be understood that is for the sake of example and is not meant to be limiting. Rather, it should be understood that these are some models that can be trained using the per-core gradient clipping technique described herein (e.g., with respect to FIGS. 2 and 4) and subsequently utilized by the client device 310 and the one or more cloud-based automated assistant component(s) 370. Further, it should be understood that additional or alternative models are contemplated herein.

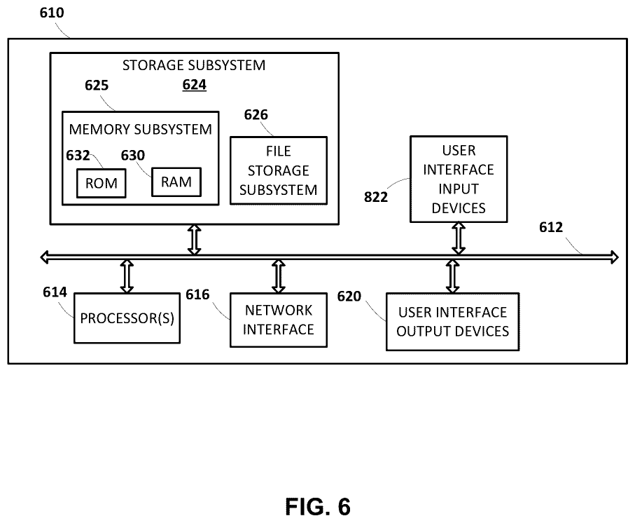

Turning now to FIG. 4, a flowchart illustrating an example method 400 of training a machine learning (ML) model using a per-core gradient clipping technique is depicted. For convenience, the operations of the method 400 are described with reference to a system that performs the operations. The system of method 400 includes one or more processors and/or other component(s) of a computing device (e.g., the remote system 120 of FIG. 1, computing device 610 of FIG. 6, and/or other computing devices). Moreover, while operations of the method 400 are shown in a particular order, this is not meant to be limiting. One or more operations may be reordered, omitted, or added.

At block 452, the system obtains a plurality of training instances to be utilized in training a machine learning (ML) model. In various implementations, the plurality of training instances that are obtained may be based on a type of the ML model that is being trained (e.g., audio-based ML model, vision-based ML model, text-based ML model, multi-modal ML models, and/or other ML models). Further, in some versions of those implementations, the plurality of training instances that are obtained can be based on the ML model of the type of the ML model that is being trained.

In some implementations, the ML model that is being trained can be an audio-based ML model. The audio-based ML model can be, for example, an automatic speech recognition (ASR) model, a hotword model, a continued conversation model, and/or other audio-based ML models. In some versions of these implementations, the system can obtain a plurality of audio data instances (e.g., from an audio or audio-visual data repository) and obtain a corresponding training signal for each of the plurality of audio data instances (if available). For example, in implementations where the ML model is an ASR model, the plurality of audio data instances can include speech and the corresponding training signal for each of the plurality of audio data instances can include a ground truth transcription for the speech captured in the plurality of audio data instances. As another example, in implementations where the ML model is a hotword model, the plurality of audio data instances can include speech and the corresponding training signal for each of the plurality of audio data instances can include a ground truth indication of whether the speech captured in the plurality of audio data instances captures a particular word or phrase that, when detected, invoked an automated assistant. As yet another example, in implementations where the ML model is a continued conversation model, the plurality of audio data instances can include speech and the corresponding training signal for each of the plurality of audio data instances can include a ground truth indication of whether component(s) of the automated assistant should remain active in anticipation of receiving further audio data. In additional or alternative implementations, the system can obtain a plurality of textual data instances (e.g., from textual data repository), process the plurality of textual data instances to generate the plurality of audio data instances (e.g., using a text-to-speech (TTS) model) and a corresponding training signal for each of the plurality of textual data instances.

In additional or alternative implementations, the ML model that is being trained can be a vision-based ML model. The vision-based ML model can be, for example, a visual language model (VLM), an object analysis model (e.g., an object detection model, an object classification model, etc.), a hotword free invocation model, and/or other vision-based ML models. In some versions of these implementations, the remote processor(s) can obtain a plurality of vision data instances (e.g., images or a sequence of images (e.g., video frames) from a vision data repository) and obtain a corresponding training signal for each of the plurality of vision data instances. For example, in implementations where the ML model is a VLM, the plurality of vision data instances can include an image (and optionally a prompt asking a question or the like about the image, hence the VLM being one example of a multi-modal ML model) and the corresponding training signal for each of the plurality of vision data instances can include ground truth information about objects, entities, or the like captured in the plurality of vision data instances. As another example, in implementations where the ML model is an object analysis model, the plurality of vision data instances can include an image and the corresponding training signal for each of the plurality of vision data instances can include a ground truth signal with respect to objects that are captured in the image, bounding boxes for objects captured in the image, etc. As yet another example, in implementations where the ML model is a hotword free invocation model, the plurality of vision data instances can include an image of a person making a gesture and the corresponding training signal for each of the plurality of audio data instances can include a ground truth indication of whether the person making the gesture should invoke or otherwise control an automated assistant.

In additional or alternative implementations, the ML model that is being trained can be a text-based ML model. The text-based ML model can be, for example, a language model (LM), a large language model (LLM), a natural language understanding (NLU) model, and/or other text-based ML models. In some versions of these implementations, the remote processor(s) can obtain a plurality of textual data instances (e.g., text from a textual data repository) and obtain a corresponding training signal for each of the plurality of textual data instances. For example, in implementations where the ML model is a LM or an LLM, the plurality of textual data instances can include text (and optionally a prompt asking a question or the like about the text or a task to be performed with respect to the text (e.g., a summarization task or the like)) and the corresponding training signal for each of the plurality of vision data instances can include ground truth information about the text, a ground truth token or ground truth sequence of tokens for text that is predicted to follow, etc. As another example, in implementations where the ML model is a NLU model, the plurality of textual data instances can include a text and the corresponding training signal for each of the plurality of textual data instances can include intent(s), slot value(s) for parameter(s) associated with the intent(s), and/or other information related to the text.

At block 454, the system identifies a plurality of compute cores of a remote system. In some implementations, the plurality of compute cores can be those of a single high-performance server. In additional or alternative implementations, the plurality of compute cores can be distributed across a cluster of high-performance servers that are co-located (e.g., located within the same facility or server farm) or not co-located (e.g., located at different facilities or different server farms).

At block 456, the system processes, at a given compute core, of the plurality of compute cores, of the remote system and using the ML model, a subset of the plurality of training instances to generate corresponding gradients. Notably, the system can generate the corresponding gradients at the given compute core in different manners based on the type of ML model that is being trained. Notably, the corresponding gradients can be generated using one or more conventional techniques and based on, for example, derivatives of a loss function(s) that are determined during training.

For example, in implementations where the ML model is an audio-based ML model, the system can cause the audio-based ML model to process a given audio data instance for a given training instance to generate given predicted audio-based output, compare the given predicted audio-based output to the corresponding training signal, and generate a given corresponding gradient based on comparing the given predicted audio-based output and the corresponding training signal. The system can repeat this process for each training instance included in the subset of the plurality of training instances selected for the given compute core to generate the corresponding gradients for the given compute core.

As another example, in implementations where the ML model is a vision-based ML model, the system can cause the vision-based ML model to process a given vision data instance for a given training instance to generate given predicted vision-based output, compare the given predicted vision-based output to the corresponding training signal, and generate a given corresponding gradient based on comparing the given predicted vision-based output and the corresponding training signal. The system can repeat this process for each training instance included in the subset of the plurality of training instances selected for the given compute core to generate the corresponding gradients for the given compute core.

As yet another example, in implementations where the ML model is a text-based ML model, the system can cause the text-based ML model to process a given textual data instance for a given training instance to generate given predicted text-based output, compare the given predicted text-based output to the corresponding training signal, and generate a given corresponding gradient based on comparing the given predicted text-based output and the corresponding training signal. The system can repeat this process for each training instance included in the subset of the plurality of training instances selected for the given compute core to generate the corresponding gradients for the given compute core.

At block 458, the system determines, based on the corresponding gradients for each training instance included in the corresponding subset of the plurality of training instances, a corresponding mean gradient. For example, the system can add all of the corresponding together to determine a corresponding summed gradient, and then divide the corresponding summed gradient by a quantity of training instances that were selected for inclusion in the corresponding subset of training instances that were processed by the given compute core.

At block 460, the system clips, based on a clipping bound, the corresponding mean gradient for the given compute core to generate a corresponding per-core gradient for the given compute core. Notably, the clipping bound can define a maximum size of the corresponding per-core gradients. In some implementations, the clipping bound can be a fixed clipping bound that is determined (e.g., defined by a developer) prior to generating the corresponding per-core gradients at each of the plurality of compute cores. In other implementations, the clipping bound can be a dynamic clipping bound that is determined based on a smallest corresponding per-core gradient generated across the plurality of compute cores.

At block 462, the system determines whether there is a given additional compute core, of the plurality of compute cores, of the remote system. If, at an iteration of block 462, the system determines that there is a given additional compute core, of the plurality of compute cores, of the remote system for which a corresponding per-core gradient has not been generated, then the system returns to block 456 and continues with an additional iteration of the method 400, but with respect to the given additional compute core. However, it should be noted that processing by each of the plurality of compute cores can additionally, or alternatively, be parallelized. It should be understood that the operations of block 462 are provided for the sake of illustrating processing by the system for the given compute core.

If, at an iteration of block 462, the system determines that there is not a given additional compute core, of the plurality of compute cores, of the remote system for which a corresponding per-core gradient has not been generated, then the system proceeds to block 464. At block 464, the system updates, based on the corresponding per-core gradients generated for the plurality of compute cores, the ML model. For example, the system can backpropagate the corresponding per-core gradients generated for the plurality of compute cores (or a corresponding mean per-core gradient for a round of training as indicated by 250 in the block diagram of FIG. 2) across the ML model to cause the ML model to be updated.

At block 466, the system determines whether one or more conditions are satisfied. The one or more conditions can include, for example, whether the plurality of cores utilized in training the ML model satisfies a core quantity threshold, whether the ML model has been updated based on a threshold quantity of corresponding per-core gradients, whether the ML model has been trained for a threshold duration of time, whether the ML model has been trained using a threshold quantity of computing resources, whether performance of the ML model satisfies a performance threshold, and/or other conditions.

If, at an iteration of block 466, the system determines that the one or more conditions are not satisfied, then the system returns to block 452 to obtain a plurality of additional training instances to be utilized in training the ML model and continues with an additional iteration of the method 400, but with respect to the plurality of additional training instances.

If, at an iteration of block 466, the system determines that the one or more conditions are satisfied, then the system proceeds to block 468. At block 468, the system causes the ML model to be deployed. For example, the system can cause the ML model to be utilized remotely from client devices by a server. Additionally, or alternatively, the system can cause an instance of the ML model to be transmitted to client devices for utilization locally by the client devices.

Turning now to FIG. 5, a flowchart illustrating an example method 500 of benchmark testing of an automatic speech recognition (ASR) model is depicted. For convenience, the operations of the method 500 are described with reference to a system that performs the operations. The system of method 500 includes one or more processors and/or other component(s) of a computing device (e.g., the remote system 120 of FIG. 1, computing device 610 of FIG. 6, and/or other computing devices). Moreover, while operations of the method 500 are shown in a particular order, this is not meant to be limiting. One or more operations may be reordered, omitted, or added.

At block 552, the system obtains an automatic speech recognition (ASR) model that was previously trained. In some implementations, the ASR model can be a first-party ASR model that was previously trained by a first-party entity. In other implementations, the ASR model can be a third-party ASR model that was previously trained by a third-party entity.

At block 554, the system obtains a plurality of testing instances for benchmark testing of the ASR model that was previously trained, the plurality of testing instances including at least a holdout set of testing instances and a canary set of testing instances. The holdout set of testing instances can be obtained (e.g., from the benchmark testing instances database 180A), for example, by the holdout testing instance engine 181, and can include data that was not seen (or not processed) by the ASR model during the previous training. Further, the canary set of testing instances can be obtained (e.g., from the training instances database 130A and/or from the benchmark testing instances database 180A), for example, by the canary testing instance engine 182, and can include data that was seen (or processed) by the ASR model during the previous training. However, in various implementations, the speed of audio data for the canary testing instances can be sped up (e.g., using a text-to-speech model) relative to the speed of the canary testing instances that were processed during training. Put another way, the canary testing instances can capture the same speech that was processed during training, but that same speech can be sped up during benchmark testing to aide in determining whether the ASR model is generalizing well from what was processed during training or whether the ASR model has simply memorized what was processed during training.

At block 556, the system processes, using the ASR model, corresponding audio data for each of the plurality of testing instances to generate a corresponding predicted ASR output for each of the plurality of testing instances. For example, the system can process, using the ASR model, corresponding audio data in each of the plurality of testing instances to generate a corresponding transcription, as the corresponding predicted ASR output, that is predicted to correspond to speech captured in the corresponding audio data. In some implementations, the ASR model may be an end-to-end speech recognition model that is capable of generating the corresponding transcription directly using the ASR model (e.g., on a character-by-character basis or other token-by-token basis). In other implementations, the ASR model may not be an end-to-end speech recognition model that generates predicted phoneme(s) (and/or other representations), and then determines the corresponding transcription based on the predicted phoneme(s). In doing so, the ASR model can optionally employ a decoding graph, a lexicon, and/or other resource(s).

At block 558, the system determines, based on comparing the corresponding predicted ASR output for each of the plurality of testing instances to a corresponding ground truth ASR output for each of the plurality of testing instances, a corresponding error rate for each of the plurality of testing instances. For example, the system can cause the error engine 183 to compare, for each of the testing instances, the corresponding transcription generated by the ASR model to a corresponding ground truth transcription that actually corresponds to the speech captured in the audio data. In some implementations, the error rate can be character error rate (CER) that indicates a character-by-character error for the corresponding predicted ASR output as compared to the corresponding ground truth ASR output. In additional or alternative implementations, the error rate can be a word error rate (WER) that indicates a word-by-word error for the corresponding predicted ASR output as compared to the corresponding ground truth ASR output.

At block 560, the system determines, based on comparing the corresponding error rate for the holdout set of testing instances to the corresponding error for the canary set of testing instances, an extent of memorization of the ASR model. At block 562, the system determines whether the extent of memorization of the ASR model satisfies a memorization threshold. For example, the CER and/or the WER for the holdout set of testing instances can be compared to the CER and/or WER for the canary set of testing instances. In this example, the CER and/or WER for the canary set of testing instances being less (or less by more than a threshold quantity) than the CER and/or the WER for the holdout set of testing instances may be indicative of the ASR model memorizing data that was processed during training of the ASR model. Put another way, if the ASR models performs better on the canary set of testing instances (e.g., that were seen during training) than the holdout set of testing instances (e.g., that were not see during training), then that may be indicative of the ASR model memorizing data associated with the canary testing instances that was processed during training of the ASR model. As another example, the CER and/or WER for the canary set of testing instances (and without considering the CER and/or WER of the holdout set of testing instances) may still be indicative of the ASR model memorizing data associated with the canary testing instances that was processed during training of the ASR model, but the CER and/or WER of the holdout set of testing instances provides a good performance baseline for the ASR model. Accordingly, the extent of memorization of the ASR model can be embodied by the difference between the CER and/or the WER for the holdout set of testing instances and the CER and/or WER for the canary set of testing instances.

If, at an iteration of block 562, the system determines that the extent of memorization of the ASR model does not satisfy the memorization threshold, then the system proceeds to block 564. At block 564, the system causes a suggestion to deploy the ASR model to be provided. For example, if the system determines that the ASR model did not memorize data from the training phase, then the system can notify a developer associated with the ASR model (e.g., as first-party developer and/or a third-party developer), via a respective client device, that the ASR model can be deployed with little to no risk of the ASR model being attacked to reveal training data.

If, at an iteration of block 562, the system determines that the extent of memorization of the ASR model satisfies the memorization threshold, then the system proceeds to block 566. At block 566, the system causes a suggestion to re-train or further train the ASR model to be provided. For example, if the system determines that the ASR model did memorize data from the training phase, then the system can notify a developer associated with the ASR model (e.g., as first-party developer and/or a third-party developer), via a respective client device, that the ASR model should be further trained and/or re-trained to mitigate and/or eliminate risk of the ASR model being attacked to reveal training data.

Turning now to FIG. 6, a block diagram of an example computing device 610 that may optionally be utilized to perform one or more aspects of techniques described herein is depicted. In some implementations, one or more of a client device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIGS. 1 and 3.

These software modules are generally executed by processor 614 alone or in combination with other processors. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method performed by one or more processors of a client device is provided herein, and includes: obtaining a plurality of training instances to be utilized in training a machine learning (ML) model; identifying a plurality of compute cores of the remote system; and generating, based on the plurality of training instances, a corresponding per-core gradient at each of the plurality of compute cores of the remote system and using per-core gradient clipping. Generating the corresponding per-core gradient at a given compute core, of the plurality of compute cores, and using per-core gradient clipping includes: processing, using the ML model, a corresponding subset of the plurality of training instances to generate corresponding gradients; determining, based on the corresponding gradients for each training instance included in the corresponding subset of the plurality of training instances, a corresponding mean gradient; and clipping, based on a clipping bound, the corresponding mean gradient for the given compute core to generate the corresponding per-core gradient. The method further includes updating, based on the corresponding per-core gradient generated for the plurality of compute cores, the ML model.

These and other implementations of the technology can include one or more of the following features.

In some implementations, the clipping bound may define a maximum size of the corresponding per-core gradient. In some versions of those implementations, the clipping bound may be a fixed clipping bound that is determined prior to generating the corresponding per-core gradients at each of the plurality of compute cores of the remote system. In additional or alternative versions of those implementations, the clipping bound may be a dynamic clipping bound that is determined based on a smallest corresponding per-core gradient generated across the plurality of compute cores of the remote system.

In some implementations, the method may further include, prior to generating the corresponding per-core gradient at the given compute core and using per-core gradient clipping: initializing, at each of the plurality of compute cores, a corresponding instance of the ML model. Processing the corresponding subset of the plurality of training instances to generate the corresponding gradients, at the given compute core, may be using the corresponding instance of the ML model that is initialized at the given compute core. In some further versions of those implementations, the method may further include selecting, for each of the plurality of compute cores, the corresponding subset of the plurality of training instances to be processed to generate the corresponding gradients. A quantity of the training instances selected for inclusion in the corresponding subset of the plurality of training may be based on one or more criteria. In some further versions of those implementations, the one or more criteria may include one or more of: a model size of the instance of the ML model, or a training instance size of the plurality of training instances.

In some implementations, generating the corresponding per-core gradient at a given additional compute core, of the plurality of compute cores, and using per-core gradient clipping may include: processing, using the ML model, an additional subset of the plurality of training instances to generate corresponding additional gradients; determining, based on the corresponding additional gradients for each training instance included in the corresponding additional subset of the plurality of training instances, a corresponding additional mean gradient; and clipping, based on the clipping bound, the corresponding additional mean gradient for the given additional compute core to generate the corresponding per-core gradient.

In some implementations, the plurality of compute cores may include one or more of: tensor processing units (TPUs), graphics processing units (GPUs), central processing units (CPUs), field programmable gate arrays (FPGAs), or application-specific integrated circuits (ASICs).

In some implementations, the remote system may be a high-performance server, and the plurality of compute cores may be executed in a centralized manner by the high-performance server.

In some implementations, the remote system may be a cluster of high-performance servers, and the plurality of compute cores may be executed in a distributed manner by the cluster of high-performance servers.

In some implementations, the ML model may be an audio-based ML model that processes audio data, and the audio-based ML model may be one of: an automatic speech recognition (ASR) model, a hotword model, or a continued conversation model. In some versions of those implementations, obtaining the plurality of training instance to be utilized in training the ML model may include: obtaining, from an audio data repository, a plurality of audio data instances; and obtaining, based on a type of the audio-based ML model, a corresponding training signal for each of the plurality of audio data instances. In additional or alternative versions of those implementations, obtaining the plurality of training instance to be utilized in training the ML model may include: obtaining, from a textual data repository, a plurality of textual data instances; processing, using a text-to-speech (TTS) model, the plurality of textual data instances to generate a plurality of audio data instances; and obtaining, based on a type of the audio-based ML model, a corresponding training signal for each of the plurality of audio data instances. In additional or alternative versions of those implementations, processing a given training instance, included in the corresponding subset of the plurality of training instances, to generate a given corresponding gradient, of the corresponding gradients, may include: processing, using the audio-based ML model, a given audio data instance for the given training instance to generate given predicted audio-based output; comparing the given predicted audio-based output to the corresponding training signal for the given training instance; and generating, based on comparing the given predicted audio-based output to the corresponding training signal for the given training instance, the given corresponding gradient.

In some implementations, the ML model may be a vision-based ML model that processes vision data, and the vision-based ML model may be one of: a visual language model (VLM), an object analysis model, or a hotword free invocation model. In some versions of those implementations, obtaining the plurality of training instance to be utilized in training the ML model may include: obtaining, from a vision data repository, a plurality of vision data instances; and obtaining, based on a type of the vision-based ML model, a corresponding training signal for each of the plurality of vision data instances. In some further versions of those implementations, processing a given training instance, included in the corresponding subset of the plurality of training instances, to generate a given corresponding gradient, of the corresponding gradients, may include: processing, using the vision-based ML model, a given vision data instance for the given training instance to generate given predicted vision-based output; comparing the given predicted vision-based output to the corresponding training signal for the given training instance; and generating, based on comparing the given predicted vision-based output to the corresponding training signal for the given training instance, the given corresponding gradient.

In some implementations, the ML model may be a text-based ML model that processes textual data, and the text-based ML model may be one of: a language model (LM), a large language model (LLM), or a natural language understanding (NLU) model. In some versions of those implementations, obtaining the plurality of training instance to be utilized in training the ML model may include: obtaining, from a textual data repository, a plurality of textual data instances; and obtaining, based on a type of the text-based ML model, a corresponding training signal for each of the plurality of textual data instances. In some further versions of those implementations, processing a given training instance, included in the corresponding subset of the plurality of training instances, to generate a given corresponding gradient, of the corresponding gradients, may include: processing, using the text-based ML model, a given textual data instance for the given training instance to generate given predicted text-based output; comparing the given predicted text-based output to the corresponding training signal for the given training instance; and generating, based on comparing the given predicted text-based output to the corresponding training signal for the given training instance, the given corresponding gradient.

In some implementations, a method performed by one or more processors of a client device is provided herein, and includes: obtaining an automatic speech recognition (ASR) model that was previously trained; obtaining a plurality of testing instances for benchmark testing of the ASR model that was previously trained, the plurality of testing instances including at least a holdout set of testing instances and a canary set of testing instances, the holdout set of testing instances being unseen by the ASR model during the previous training, and the canary set of testing instances being seen by the ASR model during the previous training; processing, using the ASR model, corresponding audio data for each of the plurality of testing instances to generate a corresponding predicted ASR output for each of the plurality of testing instances; determining, based on comparing the corresponding predicted ASR output for each of the plurality of testing instances to a corresponding ground truth ASR output for each of the plurality of testing instances, a corresponding error rate for each of the plurality of testing instances; determining, based on comparing the corresponding error rate for the holdout set of testing instances to the corresponding error rate for the canary set of testing instances, an extent of memorization by the ASR model from the previous training; and determining, based on the extent of memorization by the ASR model from the previous training, a suggested action with respect to the ASR model.

These and other implementations of the technology can include one or more of the following features.

In some implementations, the corresponding error rate for each of the plurality of testing instances may be a corresponding character error rate (CER) that indicates a character-by-character error for the corresponding predicted ASR output as compared to the corresponding ground truth ASR output.

In some implementations, the corresponding error rate for each of the plurality of testing instances may be a corresponding word error rate (WER) that indicates a word-by-word error for the corresponding predicted ASR output as compared to the corresponding ground truth ASR output.

In some implementations, the corresponding audio data for each testing instance, included in the canary set of testing instances, may be sped up as compared to corresponding training audio data that was processed by the ASR model during the previous training.

In some implementations, the ASR model may be a first-party ASR model that was previously trained by a first-party entity.

In some implementations, the ASR model may be a third-party ASR model that was previously trained by a third-party entity.

In some implementations, determining a suggested action with respect to the ASR model based on the extent of memorization by the ASR model from the previous training may include: determining whether the extent of memorization by the ASR model from the previous training satisfies a memorization threshold; and in response to determining that the extent of memorization by the ASR model from the previous training satisfies the memorization threshold: determining that the ASR model needs to be re-trained or needs further training; and generating the suggested action that indicates that the ASR model needs to be re-trained or needs further training. In some versions of those implementations, the method may further include, in response to determining that the extent of memorization by the ASR model from the previous training fails to satisfy the memorization threshold: determining that the ASR model should be deployed; and generating the suggested action that indicates that the ASR model should be deployed.

Various implementations can include a non-transitory computer readable storage medium storing instructions executable by one or more processors (e.g., central processing unit(s) (CPU(s)), graphics processing unit(s) (GPU(s)), digital signal processor(s) (DSP(s)), and/or tensor processing unit(s) (TPU(s)) to perform a method such as one or more of the methods described herein. Other implementations can include an automated assistant client device (e.g., a client device including at least an automated assistant interface for interfacing with cloud-based automated assistant component(s)) that includes processor(s) operable to execute stored instructions to perform a method, such as one or more of the methods described herein. Yet other implementations can include a system of one or more servers that include one or more processors operable to execute stored instructions to perform a method such as one or more of the methods described herein.

What is claimed is:

1. A method implemented by one or more processors at a remote system, the method comprising:
obtaining a plurality of training instances to be utilized in training a machine learning (ML) model;
identifying a plurality of compute cores of the remote system;
generating, based on the plurality of training instances, a corresponding per-core gradient at each of the plurality of compute cores of the remote system and using per-core gradient clipping, wherein generating the corresponding per-core gradient at a given compute core, of the plurality of compute cores, and using per-core gradient clipping comprises:
processing, using the ML model, a corresponding subset of the plurality of training instances to generate corresponding gradients;
determining, based on the corresponding gradients for each training instance included in the corresponding subset of the plurality of training instances, a corresponding mean gradient; and
clipping, based on a clipping bound, the corresponding mean gradient for the given compute core to generate the corresponding per-core gradient; and
updating, based on the corresponding per-core gradient generated for the plurality of compute cores, the ML model.

2. The method of claim 1, wherein the clipping bound defines a maximum size of the corresponding per-core gradient.

3. The method of claim 2, wherein the clipping bound is a fixed clipping bound that is determined prior to generating the corresponding per-core gradients at each of the plurality of compute cores of the remote system.

4. The method of claim 2, wherein the clipping bound is a dynamic clipping bound that is determined based on a smallest corresponding per-core gradient generated across the plurality of compute cores of the remote system.

5. The method of claim 1, further comprising:
prior to generating the corresponding per-core gradient at the given compute core and using per-core gradient clipping:
initializing, at each of the plurality of compute cores, a corresponding instance of the ML model,
wherein processing the corresponding subset of the plurality of training instances to generate the corresponding gradients, at the given compute core, is using the corresponding instance of the ML model that is initialized at the given compute core.

6. The method of claim 5, further comprising:
selecting, for each of the plurality of compute cores, the corresponding subset of the plurality of training instances to be processed to generate the corresponding gradients,
wherein a quantity of the training instances selected for inclusion in the corresponding subset of the plurality of training is based on one or more criteria.

7. The method of claim 6, wherein the one or more criteria comprise one or more of: a model size of the instance of the ML model, or a training instance size of the plurality of training instances.

8. The method of claim 1, wherein generating the corresponding per-core gradient at a given additional compute core, of the plurality of compute cores, and using per-core gradient clipping comprises:
processing, using the ML model, an additional subset of the plurality of training instances to generate corresponding additional gradients;
determining, based on the corresponding additional gradients for each training instance included in the corresponding additional subset of the plurality of training instances, a corresponding additional mean gradient; and
clipping, based on the clipping bound, the corresponding additional mean gradient for the given additional compute core to generate the corresponding per-core gradient.

9. The method of claim 1, wherein the ML model is an audio-based ML model that processes audio data, and wherein the audio-based ML model is one of: an automatic speech recognition (ASR) model, a hotword model, or a continued conversation model.

10. The method of claim 9, wherein obtaining the plurality of training instance to be utilized in training the ML model comprises:
obtaining, from an audio data repository, a plurality of audio data instances; and
obtaining, based on a type of the audio-based ML model, a corresponding training signal for each of the plurality of audio data instances.

11. The method of claim 9, wherein obtaining the plurality of training instance to be utilized in training the ML model comprises:
obtaining, from a textual data repository, a plurality of textual data instances;
processing, using a text-to-speech (TTS) model, the plurality of textual data instances to generate a plurality of audio data instances; and
obtaining, based on a type of the audio-based ML model, a corresponding training signal for each of the plurality of audio data instances.

12. The method of claim 9, wherein processing a given training instance, included in the corresponding subset of the plurality of training instances, to generate a given corresponding gradient, of the corresponding gradients, comprises:
processing, using the audio-based ML model, a given audio data instance for the given training instance to generate given predicted audio-based output;
comparing the given predicted audio-based output to the corresponding training signal for the given training instance; and
generating, based on comparing the given predicted audio-based output to the corresponding training signal for the given training instance, the given corresponding gradient.

13. The method of claim 1, wherein the ML model is a vision-based ML model that processes vision data, and wherein the vision-based ML model is one of: a visual language model (VLM), an object analysis model, or a hotword free invocation model.

14. The method of claim 13, wherein obtaining the plurality of training instance to be utilized in training the ML model comprises:
obtaining, from a vision data repository, a plurality of vision data instances; and
obtaining, based on a type of the vision-based ML model, a corresponding training signal for each of the plurality of vision data instances.

15. The method of claim 14, wherein processing a given training instance, included in the corresponding subset of the plurality of training instances, to generate a given corresponding gradient, of the corresponding gradients, comprises:
processing, using the vision-based ML model, a given vision data instance for the given training instance to generate given predicted vision-based output;
comparing the given predicted vision-based output to the corresponding training signal for the given training instance; and
generating, based on comparing the given predicted vision-based output to the corresponding training signal for the given training instance, the given corresponding gradient.

16. The method of claim 1, wherein the ML model is a text-based ML model that processes textual data, and wherein the text-based ML model is one of: a language model (LM), a large language model (LLM), or a natural language understanding (NLU) model.

17. The method of claim 16, wherein obtaining the plurality of training instance to be utilized in training the ML model comprises:
obtaining, from a textual data repository, a plurality of textual data instances; and
obtaining, based on a type of the text-based ML model, a corresponding training signal for each of the plurality of textual data instances.

18. The method of claim 17, wherein processing a given training instance, included in the corresponding subset of the plurality of training instances, to generate a given corresponding gradient, of the corresponding gradients, comprises:
processing, using the text-based ML model, a given textual data instance for the given training instance to generate given predicted text-based output;
comparing the given predicted text-based output to the corresponding training signal for the given training instance; and
generating, based on comparing the given predicted text-based output to the corresponding training signal for the given training instance, the given corresponding gradient.

19. A system comprising:
at least one processor; and
memory storing instructions that, when executed, cause the at least one processor to be operable to:
obtain a plurality of training instances to be utilized in training a machine learning (ML) model;
identify a plurality of compute cores of the remote system;
generate, based on the plurality of training instances, a corresponding per-core gradient at each of the plurality of compute cores of the remote system and using per-core gradient clipping, wherein the instructions to generate the corresponding per-core gradient at a given compute core, of the plurality of compute cores, and using per-core gradient clipping comprise instructions to:
process, using the ML model, a corresponding subset of the plurality of training instances to generate corresponding gradients;
determine, based on the corresponding gradients for each training instance included in the corresponding subset of the plurality of training instances, a corresponding mean gradient; and
clip, based on a clipping bound, the corresponding mean gradient for the given compute core to generate the corresponding per-core gradient; and
update, based on the corresponding per-core gradient generated for the plurality of compute cores, the ML model.

20. A non-transitory computer-readable storage medium storing instructions that, when executed, cause at least one processor to execute the instructions to:
obtain a plurality of training instances to be utilized in training a machine learning (ML) model;
identify a plurality of compute cores of the remote system;
generate, based on the plurality of training instances, a corresponding per-core gradient at each of the plurality of compute cores of the remote system and using per-core gradient clipping, wherein the instructions to generate the corresponding per-core gradient at a given compute core, of the plurality of compute cores, and using per-core gradient clipping comprise instructions to:
process, using the ML model, a corresponding subset of the plurality of training instances to generate corresponding gradients;
determine, based on the corresponding gradients for each training instance included in the corresponding subset of the plurality of training instances, a corresponding mean gradient; and
clip, based on a clipping bound, the corresponding mean gradient for the given compute core to generate the corresponding per-core gradient; and
update, based on the corresponding per-core gradient generated for the plurality of compute cores, the ML model.
